(19) United States
(12) Patent Application Publication
(10) Pub. No.: US 2023/0192485 A1
(43) Pub. Date: Jun. 22, 2023

(54) PROCESS FOR GENERATING A PURIFIED HYDROGEN PRODUCT FROM HEAVY HYDROCARBON FEEDSTOCKS

(71) Applicants: Frank J. Klein, III, Seabrook, TX (US); Andrew M. Warta, Wheatfield, NY (US); Axel Behrens, München (DE); Stephanie Neuendorf, Wolfratshausen (DE); Troy M. Raybold, Colden, NY (US); Nicole Schödel, München (DE); Andreas Peschel, Wolfratshausen (DE); Martin Lang, München (DE)

(72) Inventors: Frank J. Klein, III, Seabrook, TX (US); Andrew M. Warta, Wheatfield, NY (US); Axel Behrens, München (DE); Stephanie Neuendorf, Wolfratshausen (DE); Troy M. Raybold, Colden, NY (US); Nicole Schödel, München (DE); Andreas Peschel, Wolfratshausen (DE); Martin Lang, München (DE)

(21) Appl. No.: 18/064,995

(22) Filed: Dec. 13, 2022

Related U.S. Application Data
(60) Provisional application No. 63/290,942, filed on Dec. 17, 2021.

(51) Int. Cl. C01B 3/40; C01B 3/48; C01B 3/50; C01B 3/56

(52) U.S. Cl. CPC C01B 3/40; C01B 3/48; C01B 3/506; C01B 3/56; C01B 2203/0233; C01B 2203/0283; C01B 2203/1058; C01B 2203/1241; C01B 2203/1247; C01P 2006/80; C01B 2203/0883; C01B 2203/046; C01B 2203/0495; C01B 2203/0475; C01B 2203/042; C01B 2203/0811

(57) ABSTRACT

A process for producing a purified hydrogen product without a pre-reformer or pre-reforming catalyst in a fired, tubular reformer where the feed stream having a carbon (i.e., C₂+) molar composition greater than or equal to five percent and is mixed with a steam stream to yield a reformer feed stream with a steam-to-carbon ratio less than or equal to three. The reformer tubes contain a nickel-based catalyst without alkali promotion.

### RELATED APPLICATION

The present application claims priority from U.S. Provisional Application Ser. No. 63/290,942, filed Dec. 17, 2021, which is incorporated by reference herein in its entirety.

### FIELD OF THE INVENTION

The invention relates to a process for producing a purified hydrogen product without a pre-reformer or pre-reforming catalyst in a fired, tubular reformer where the feed stream having a carbon (i.e., C₂+) molar composition greater than or equal to five percent and is mixed with a steam stream to yield a reformer feed stream with a steam-to-carbon ratio less than or equal to three. The reformer tubes contain a nickel-based catalyst without alkali promotion.

### BACKGROUND OF THE INVENTION

The industrial production of hydrogen is often achieved through the reforming of hydrocarbon species with steam in a steam reformer. Reformers for hydrogen production typically employ metal-based (e.g., nickel) reforming catalysts to convert hydrocarbon feedstocks and steam into hydrogen and carbon monoxide (CO). The general steam reforming reaction

CₓH_{y}+xH₂O [symbol] xCO+(y/2+x)H₂ (1)

is endothermic, requiring heat input which is typically supplied by a fired furnace to reach high conversions of hydrocarbons, such as methane (CH₄) to H₂.

A feed stream for a steam reformer may contain multiple hydrocarbon species such as methane (CH₄), ethane (C₂H₆), propane (C₃H₈) and other heavier hydrocarbons. The steam-to-carbon ratio—that is the ratio of steam molecules added to carbon atoms that react with steam in the feedstock—will be greater for a heavier feedstock (i.e., the concentration of hydrocarbons with more than one carbon molecule increases). A feed consisting of primarily one-carbon molecule hydrocarbons (i.e., CH₄) will typically require a lower steam-to-carbon ratio than a feed containing multiple percent levels of C₂H₆ and other higher hydrocarbons (e.g., C₃H₈, butane C₄H₁₀, ethene C₂H₄, etc.). Generally, the C₃+ molar composition is ≥1% and preferably ≥2%. The greater steam-to-carbon ratio is required to avoid carbon formation within the catalyst filled reformer tubes. Carbon formation may lead to reduced catalyst activity, increased pressure drop through the tube, irreversible damage to the catalyst pellets, and potentially the need to shut down the plant and replace the catalyst. When it occurs, carbon formation will typically begin in the upper half of the reformer tubes for a top-fired reforming furnace.

To protect against carbon formation for heavier feedstocks, alkali-promoted (e.g., potassium promoted) catalysts are typically required in the upper section of reforming tubes. Potassium addition to steam reforming catalysts is well known. Borowiecki et al. published in Applied Surface Science 300 (2014) 191-200 discloses the benefit of potassium addition to the reforming catalyst surface to enhance carbon formation resistance. This promoter may leach out of the catalyst over time, reducing the carbon formation protection and potentially depositing in downstream equipment (e.g., valves, process gas coolers) leading to malfunctions and/or less efficient operation.

An alternative method of processing a heavier feedstock requires the use of a pre-reformer with a pre-reforming catalyst. Use of a pre-reformer and pre-reforming catalyst is well known. Pre-reforming may be achieved using various catalyst types including noble metals or lower cost nickel catalysts. Pre-reforming may also include the addition of an oxidant to the feed stream. Garg et al. (U.S. Pat. No. 7,427,388) discloses a process for pre-reforming a feedstock using a nickel-based pre-reforming catalyst and an oxidant to pre-reform a feed stream containing methane and higher hydrocarbons. A further embodiment describes carrying out the pre-reforming process in the top portion of a reformer. Use of a pre-reformer and/or pre-reforming catalyst requires additional unit operations, catalyst, capital cost, and complexity for the hydrogen production process.

Operating at greater steam-to-carbon ratios results in an improvement of overall hydrogen production process efficiency and reduction in CO₂ emissions. It is an object of the present invention to reduce the minimum steam-to-carbon ratio of a hydrogen production plant processing a heavier feedstock without carbon formation (coke formation) on the catalyst and/or within the reformer tube. It is another object of the invention to carry out the process without the need for additional unit operations or alkali-promoted catalysts. It is yet another object of the present invention to produce a purified hydrogen product without a pre-reformer or pre-reforming catalyst.

Other objects and aspects of the present invention will become apparent to one skilled in the art upon review of the specification, drawings and claims appended hereto.

### BRIEF SUMMARY OF INVENTION

The invention pertains to a process of operating a fired, tubular reformer to produce a purified hydrogen stream. In one aspect of the invention, the process bypasses the use of a pre-reformer and/or a pre-reformer catalyst and introduces a feed stream having a C₂+ molar composition of ≥5% that is mixed with a steam stream yielding a reformer feed stream into one or more reformer tubes with a steam-to-carbon molar ratio of ≤3 wherein the catalyst within the reformer tubes is a nickel-based catalyst with no alkali promotion. More specifically, this is a process for generating a purified hydrogen product stream. The process includes introducing a reformer feed stream having a steam-to-carbon ratio of ≤3 into one or more reformer tubes without passing the reformer feed stream through a pre-reformer and/or over a pre-reformer catalyst, whether the pre-reformer catalyst is disposed in the pre-reformer or the one or more reformer tubes, wherein the reformer feed stream is a combination of a hydrocarbon containing stream having a C₂+ composition of ≥5% and a steam stream and reforming said reformer feed stream in said one or more reformer tubes having a nickel-based catalyst with no alkali promotion to form a synthesis gas which is further processed to obtain the purified hydrogen product stream.

### DETAILED DESCRIPTION OF INVENTION

The present invention seeks to allow the processing of heavier hydrocarbon feedstocks in a steam reformer while avoiding carbon formation without the need to increase the steam-to-carbon ratio of the reformer feed, or utilize a pre-reformer, pre-reforming catalyst, or alkali promotion of the reformer catalyst.

A hydrocarbon containing stream with a C₂+ molar composition of ≥5% is fed to a hydrogen generation process (e.g., hydrogen plant) to produce a purified hydrogen product stream. The C₂+ molar composition is typically ≥8% and preferably ≥10% and an H₂ molar composition is ≤10% and preferably ≤7%. This hydrocarbon containing stream may come from a single source, or be a mixture of multiple streams such as natural gas, refinery offgases, and/or byproduct streams from a renewable diesel or sustainable aviation fuel process such as liquified petroleum gas (LPG), naphtha, offgas, or purge streams. The hydrocarbon containing stream may contain multiple hydrocarbon species with different numbers of carbon atoms such as but not limited to C₂ (e.g., ethane—C₂H₆, ethene—C₂H₄), C₃ (e.g., propane—C₃H₈, propene—C₃H₆), C₄ (e.g., n-butane or i-butane—C₄H₁₀), C₅ (e.g., n-pentane or i-pentane—C₅H₁₂), C₆ (e.g., n-hexane or i-hexane—C₆H₁₄) and above, and may be a mixture of paraffins, olefins, naphthenes and/or aromatics.

The hydrocarbon containing stream may be mixed with a hydrogen-rich stream, such as a portion of the purified hydrogen product stream to increase the hydrogen content for hydrotreating and desulfurization before being mixed with steam to yield a reformer feed stream. Following hydrotreating and desulfurization, the hydrocarbon containing stream is mixed with steam to form a reformer feed stream.

The reformer feed stream is fed to the tubes of a steam reformer, which contain a nickel-based reforming catalyst with high activity for gasification of elemental carbon, such as the catalyst provided by BASF under the trademark SYSNPIRE™ G1-110, in the carbon formation zone. This is the zone of the reformer tubes where the temperature and gas composition have the greatest likelihood to result in carbon formation on the catalyst, which is typically the top ˜10-50% of the reformer tube. The steam reformer is operated without the need for a pre-reformer reactor and/or pre-reforming catalyst, either upstream of the reformer feed stream entering the reformer tubes, or within the reformer tubes. The steam-to-carbon ratio of the reformer feed stream is ≤3, but not less than 1, and none of the catalyst in the reformer tubes is alkali promotion. The steam-to-carbon ratio can be ≤2.8, preferably ≤2.6, and most preferably ≤2.4. The steam-to-carbon ratio of the reformer feed stream is lower than typically required to avoid carbon formation within the reformer tubes for this C₂+ composition without pre-reforming or alkali promotion.

In a preferred embodiment, the reformer tubes are filled with multiple types of reforming catalyst that are layered from the bottom of the reformer tubes to the top with the catalyst with high activity for gasification of elemental carbon deployed only in the carbon formation zone. In a more preferred embodiment, a pre-reduced nickel-based catalyst is additionally layered in the top 10% of the tube, above the catalyst with high activity for gasification of elemental carbon, where the lower temperature and gas composition have a lower chance for carbon formation. All nickel-based catalysts will undergo a reduction step after being filled in the reformer tubes and prior to normal operation for hydrogen production to ensure the nickel metal is in a reduced state. This nickel-based catalyst typically contains a nickel content ranging from about 10-20% and preferably ≤20%. A pre-reduced nickel-based catalyst will undergo a reduction step prior to being filled in the reformer tubes to ensure full reduction is achieved, particularly for lower temperature regions, such as near the top of the reformer tubes.

The hydrogen generation process contains a steam reformer which is made up of a furnace which contains the catalyst-filled reformer tubes, with burners heating the tubes, such as in a top-fired steam reformer where the flames from the burners in the furnace originate at the top providing heat to the catalyst-filled reformer tubes. Instead of burners generating flames, heat may be generated electrically. The effluent from the reformer tubes is a hot synthesis gas stream, a mixture of H₂, CO, and other components such as water, CO₂, CH₄, and unreacted species in the feed.

The hydrogen generation process may additionally contain other options known to one skilled in the art, including but not limited to a water quench heat exchanger generating steam (e.g., process gas boiler) to cool the hot synthesis gas stream from the reformer tubes, and other reactors, such as various types of water gas shift reactors (e.g., high temperature, medium temperature, and/or low temperature) to further shift CO in the hot synthesis gas stream to H₂ and CO₂. The hot synthesis gas stream from the reformer tubes and water gas shift may be cooled to near ambient temperature (˜100° F.) through various heat exchangers with condensed water removed in condensate separators. Purified hydrogen product is recovered from a hydrogen pressure swing adsorption (PSA) process and unrecovered hydrogen and impurities are taken as a lower-pressure tail gas stream. This lower-pressure tail gas stream may be recycled to the furnace and used as a portion of the fuel for the burners.

Prior to entering the PSA, CO₂ from the cooled hot synthesis gas from the reformer tubes may be removed in a CO₂ removal unit, such as an amine wash unit. This CO₂ may be utilized in other chemical processes or compressed and sequestered. In some hydrogen processes where a lower H₂:CO ratio is desired, this CO₂ may be recycled into the reformer feed stream, and CO₂ may additionally be imported from outside of the process. When the hydrogen generation process is being operated for maximum hydrogen production, no CO₂-rich streams, whether generated internally or externally from the process, are mixed with any of the feed streams to be processed in the reformer tubes.

Multiple pressures of steam may be produced, including high-pressure steam for export, process steam for the reforming and water gas shift reactions, and low-pressure steam for use within the process.

In an alternative embodiment, an existing hydrogen generation process may be retrofit to accept a feed stream that was not in the original design. In a more preferred alternative embodiment, an existing hydrogen generation process may be retrofit to accept a hydrocarbon containing stream derived in part from a renewable diesel process.

The invention is further explained through the following examples, which are merely illustrative of an embodiment of the present invention, as compared to a bases case, and not to be construed as limiting the present invention in any way.

### EXAMPLE

This example demonstrates the efficiency improvement in hydrogen production when processing a feedstock with heavier hydrocarbons with a lower steam-to-carbon ratio without concerns for carbon formation compared to a standard process. The improved process has a 1% improvement in overall process efficiency.

For a process producing 100 MMSCFD of hydrogen in a steam reformer, a natural gas and a hydrogen-rich refinery offgas stream with compositions shown in Table 1 are mixed to create a mixed feedstock stream. The natural gas stream is primarily methane, with a C₂+ composition of 5.5% and <1% each of CO₂, CO, N₂, and water. The hydrogen-rich offgas stream is 48.7% methane and has a C₂+ composition of 24%, a hydrogen composition of 25.7%, and <1% each of CO₂, CO, N₂, and water.

TABLE 1

| | | Hydrogen-Rich |
|---|---|---|
| Component | Natural Gas | Offgas |
| CH₄ [mole %] | 93 | 48.7 |
| C₂ [mole %] | 5.3 | 22 |
| C₃+ [mole %] | 0.2 | 2 |
| H₂ [mole %] | 0 | 25.7 |
| CO₂ [mole %] | 0.7 | 0.1 |
| CO [mole %] | 0 | 0.8 |
| N₂ [mole %] | 0.8 | 0.5 |
| H₂O [mole %] | 0 | 0.2 |

This mixed feedstock stream is mixed with a nearly pure hydrogen recycle stream to form a combined feedstock stream. The combined feedstock stream is 83.8% methane and has a C₂+ composition of 7.5%, a hydrogen composition of 7.4%, and <1% each of CO₂, CO, N₂, and water.

This combined feedstock stream is compressed to 505 psia, preheated, and sent to a hydrotreating and desulfurization reactor to saturate any unsaturated C₂+ hydrocarbons and remove sulfur. The resulting pretreated feed stream is mixed with steam to form a mixed reformer feed stream with a steam-to-carbon ratio of 2.45. This steam-to-carbon ratio is the molar ratio of water to carbon available to react in the mixed reformer feed stream.

The mixed reformer feed stream is further preheated to 1075° F. and sent to the catalyst filled tubes of a top-fired steam reformer. The catalyst filled tubes contain three layers of nickel-based catalyst, none of which contain an alkali promotor. The topmost layer, 10% of the filled length, is a standard nickel-based reforming catalyst. The next layer, 35% of the filled length, is a carbon formation resistant catalyst, for example BASF SYNSPIRE™ G1-110. The bottom layer, 55% of the filled length, is a standard nickel-based reforming catalyst.

The reformed hot synthesis gas stream exits the catalyst filled tubes at 1566° F. with a H₂:CO molar ratio of 3.2. This reformed hot synthesis stream is cooled in a process gas boiler which generates steam and is sent to a catalyst-filled water gas shift reactor to further convert CO and steam to H₂ and CO₂. This shifted synthesis gas stream is further cooled, condensed water removed in condensate separators, and sent to a hydrogen pressure swing adsorber (H₂ PSA) to be separated into a nearly pure hydrogen product stream and lower-pressure PSA tail gas stream. A portion of the nearly pure hydrogen product stream is sent as a nearly pure hydrogen recycle stream be mixed with the incoming mixed feedstock stream. The lower-pressure PSA tail gas stream is mixed with a natural gas fuel stream and sent to the fired furnace of the steam reformer with combustion air and burned to provide the heat to the catalyst filled tubes.

A byproduct of the hydrogen production process is export steam generation. The amount of 465 psia steam at 600° F. exported by the process is 209.5 k lb/hr. The overall process efficiency is 368 MMBTU/1000 SCF of H₂ produced.

If the C₂+ concentration of the combined feedstock stream varies, for instance due to higher levels of ethane in the hydrogen-rich offgas stream, the steam-to-carbon ratio is held constant, allowing for consistent operation of the hydrogen production process.

### Comparative Example

For a standard process using a typical catalyst layering in the catalyst-filled tubes to produce 100 MMSCFD of hydrogen from a mixed feedstock stream made up of a combination of the natural gas and hydrogen-rich refinery offgas streams shown in Table 1, a greater steam-to-carbon ratio for the mixed reformer feed stream is required.

The mixed feedstock stream is mixed with a nearly pure hydrogen recycle stream to form the combined feedstock stream. The combined feedstock stream is compressed to 505 psia, preheated, and sent to a hydrotreating and desulfurization reactor. The resulting pretreated feed stream is mixed with steam to form a mixed reformer feed stream with a steam-to-carbon ratio of 2.9.

The mixed reformer feed stream is further preheated to 1075° F. and sent to the catalyst filled tubes of a top-fired steam reformer. The catalyst filled tubes contain two layers of nickel-based catalyst. The top layer, 40% of the filled length, is an alkali-promoted reforming catalyst to prevent carbon formation. The bottom layer, 60% of the filled length, is a standard reforming catalyst.

The reformed hot synthesis gas stream exits the catalyst filled tubes at 1566° F. with a H₂:CO molar ratio of 3.9. This reformed hot synthesis gas stream is cooled in a process gas boiler which generates steam and is sent to a catalyst-filled water gas shift reactor to further convert CO and steam to H₂ and CO₂. This shifted synthesis gas stream is further cooled, condensed water removed in condensate separators, and sent to a H₂ PSA to be separated into a nearly pure hydrogen product stream and lower-pressure PSA tail gas stream. A portion of the nearly pure hydrogen product stream is sent as a nearly pure hydrogen recycle stream to be mixed with the incoming mixed feedstock stream. The lower-pressure PSA tail gas stream is mixed with a natural gas fuel stream and sent to the fired furnace of the steam reformer with combustion air and burned to provide the heat to the catalyst filled tubes.

The byproduct 465 psia steam at 600° F. exported from the process is 198.2 k lb/hr. The overall process efficiency is 372 MMBTU/1000 SCF of H₂ produced.

If the C₂+ concentration of the combined feedstock increases, the steam-to-carbon ratio of the mixed reformer feed is also increased to protect against carbon formation in the catalyst filled tubes.

The present invention enables the production of a purified hydrogen stream at a reduced steam-to-carbon ratio with a 5.7% increase in export steam production and 1% improvement in overall process efficiency without the need for an alkali-promoted catalyst.

Although various embodiments have been shown and described, the present disclosure is not so limited and will be understood to include all such modifications and variations as would be apparent to one skilled in the art.

We claim:

1. A process of generating a purified hydrogen product stream, comprising: introducing a reformer feed stream having a steam-to-carbon ratio of ≤3 into one or more reformer tubes without passing said reformer feed stream through a pre-reformer and/or over a pre-reformer catalyst irrespective of whether said pre-reformer catalyst is disposed in the pre-reformer or one or more reformer tubes, wherein said reformer feed stream is a combination of a hydrocarbon containing stream having a C₂+ composition of ≥5% and a steam stream and reforming said reformer feed stream in said one or more reformer tubes having a nickel-based catalyst with no alkali promotion to form a synthesis gas which is further processed to obtain said purified hydrogen product stream.

2. The process according to claim 1 wherein the reformer feed stream steam-to-carbon ratio is ≤2.8, and preferably ≤2.6, and more preferably ≤2.4.

3. The process according to claim 1 wherein the hydrocarbon containing stream C₂+ molar composition is ≥8% and preferably ≥10%.

4. The process according to claim 1 wherein the hydrocarbon containing stream C₃+ molar composition is ≥1% and preferably ≥2%.

5. The process according to claim 1 wherein the hydrocarbon containing stream H₂ molar composition is ≤10% and preferably ≤7%.

6. The process according to claim 1 wherein the hydrocarbon containing stream H₂ molar composition is increased by mixing with a portion of the purified hydrogen product stream.

7. The process according to claim 1 wherein the hydrocarbon containing stream H₂ molar composition is not increased by mixing with a portion of the purified hydrogen product stream.

8. The process according to claim 1 wherein an existing steam reformer is retrofitted to allow for processing of a greater hydrocarbon containing stream C₂+ composition than could be processed by the original design.

9. The process according to claim 1 wherein the nickel content of the nickel-based catalyst is 10-20%.

10. The process according to claim 1 wherein the one or more reformer tubes contain a single type of nickel-based catalyst.

11. The process according to claim 1 wherein the one or more reformer tubes contain more than one type of catalyst and each is nickel-based.

12. The process according to claim 1 wherein the one or more reformer tubes contain more than one type of catalyst and at least one is nickel-based.

13. The process according to claim 1 wherein the one or more reformer tubes contain at least one nickel-based catalyst that is pre-reduced before installation.

14. The process according to claim 1 wherein none of the hydrocarbon containing stream, or reformer feed stream, or steam stream is mixed with a CO₂-rich stream derived from the hydrogen production process.

15. The process according to claim 1 wherein none of the hydrocarbon containing stream, or reformer feed stream, or steam stream is mixed with a CO₂-rich stream derived externally from the hydrogen production process.

16. The process according to claim 1 wherein a nickel-based catalyst with high activity for solid-carbon gasification is utilized in the one or more reformer tubes' carbon formation zone.

17. The process according to claim 1 wherein a flowrate of said steam stream is not adjusted based on variation of C₂+ molar composition in the hydrocarbon containing stream.

18. The process according to claim 1 wherein the synthesis gas from the reformer tubes is cooled by a water quench heat exchanger generating steam.

19. The process according to claim 1 wherein the synthesis gas from the reformer tubes is introduced into a second catalyst filled reactor to shift at least part of the CO into H₂.

20. The process according to claim 1 wherein the synthesis gas from the reformer tubes is cooled, condensed water removed, and at least a portion of the contained CO₂ is removed by a CO₂ removal system.

21. The process according to claim 1 wherein the synthesis gas from the reformer tubes is cooled, condensed water removed, and a pressure swing adsorption process purifies the stream into a purified hydrogen product and a lower-pressure tail gas stream.

22. The process according to claim 21 wherein at least a portion of the lower-pressure tail gas stream is burned in a furnace providing heat to the one or more reformer tubes.

23. The process according to claim 1 wherein the hydrocarbon containing stream is at least partially derived from a byproduct of a renewable diesel and/or sustainable aviation fuel process.

24. The process according to claim 1 wherein the hydrocarbon containing stream is at least partially derived from a byproduct of a refinery process.
